(19) United States
(12) Patent Application Publication
(10) Pub. No.: US 2017/0160612 A1
(43) Pub. Date: Jun. 8, 2017

(54) THIN FILM TRANSISTOR ARRAY SUBSTRATE AND MANUFACTURING METHOD THEREOF

(71) Applicant: Shenzhen China Star Optoelectronics Technology Co., Ltd., Shenzhen, Guangdong (CN)

(72) Inventor: Sikun HAO, Shenzhen, Guangdong (CN)

(73) Assignee: Shenzhen China Star Optoelectronics Technology Co., Ltd., Shenzhen, Guangdong (CN)

(21) Appl. No.: 14/907,308

(22) PCT Filed: Dec. 30, 2015
(86) PCT No.: PCT/CN2015/099654

§ 371 Date: Jan. 25, 2016

(30) Foreign Application Priority Data
Dec. 8, 2015 (CN) 201510898075.0

(51) Int. Cl. G02F 1/1362; G02F 1/1343; G02F 1/1339; G02F 1/1368; G02F 1/1333

(52) U.S. Cl. CPC G02F 1/136209; G02F 1/1368; G02F 1/133345; G02F 1/13394; G02F 1/134309; G02F 1/134336; G02F 2202/103; G02F 1/136227; G02F 2001/13398; G02F 2001/134318

(57) ABSTRACT

The present invention provides a thin film transistor array substrate a manufacturing method thereof. The thin film transistor array substrate comprises a transparent substrate and multiple data lines and multiple gate lines perpendicular to each other so as to divide the transparent substrate into multiple pixel regions, and the thin film transistor array substrate further comprises: multiple thin film transistors, a protection layer, an organic insulating layer, a pixel electrode and a common electrode and multiple contact holes.

### FIELD OF THE INVENTION

The present invention relates to a thin film transistor and a manufacturing method thereof, and more particularly, relates to a thin film transistor array substrate, manufacturing method thereof and liquid crystal panel.

### BACKGROUND OF THE INVENTION

Liquid crystal displays are the most widely used flat panel displays and have been widely used in various electronic equipments increasingly, such as mobile phone, personal digital assistant (PDA), digital camera, computer screen and laptop screen. With the development and progress of liquid crystal display technology, a higher requirement for display performances and designs of the liquid crystal displays has also been brought forward.

Liquid crystal panels are main accessories to the liquid crystal displays, which comprises a thin film transistor (TFT) array substrate and a color filer (CF) substrate that are vacuum laminated, and a liquid crystal layer and alignment films that are disposed between the substrates.

Since users can only see the short axis of liquid crystal molecules in a liquid crystal display of In Planes Switching (IPS) wide viewing angle technologies, there won't be much difference between pictures viewed from various angles so that visual angles of the liquid crystal display are perfectly improved. The first generation of the IPS technologies provides a new arrangement of liquid crystal molecules to avoid disadvantages of TN mode and achieve a better visual angle. The second generation of the IPS technologies (S-IPS, which is Super-IPS) improves grayscale inversions occurred in some particular angles by using herringbone electrodes and introducing dual-domain mode. The third generation of the IPS technologies (AS-IPS, which is Advanced Super-IPS) reduces the distance between liquid crystal molecules and increases aperture ratio for achieving a greater brightness.

FIG. 1 is a structural schematic view illustrating a pixel structure of a traditional liquid crystal panel that comprises: a first substrate 1′ and a second substrate 2′ that are disposed opposite to each other, and a liquid crystal layer 3′ that is disposed between the first substrate 1′ and the second substrate 2′; wherein the first substrate 1′ is a thin film transistor array substrate and the second substrate 2′ is a color filer substrate. As illustrated in figures, the second substrate 2′ includes a transparent substrate 21′, and black matrixs 22′, color filer G 23′ and color filer B 24′ that are disposed on the transparent substrate 21′.

As illustrated in FIG. 1, lights from a left pixel emit through the color filer G 23′ while lights from a right pixel emit through the color filer B 24′ when viewed from front; lights from a left pixel emit through the color filer B 24′ while lights from a right pixel emit through the color filer G 23′ when viewed from sides with a large viewing angle. Therefore, a deviation between the color viewed from the front and the color viewed from the sides is occurred, causing color cast.

As a result, it is necessary to provide a new thin film transistor array substrate and a liquid crystal panel using the thin film transistor array substrate to solve the problems existing in the conventional technologies.

### SUMMARY OF THE INVENTION

The first object of the present invention is to provide a thin film transistor array substrate comprising a transparent substrate, multiple data lines and multiple gate lines, wherein the data lines and gate lines are perpendicular to each other for dividing the transparent substrate into multiple pixel regions. The thin film transistor array substrate comprises: multiple thin film transistors, a protection layer, an organic insulating layer, a pixel electrode and a common electrode and multiple contact holes. Each thin film transistor is positioned in every pixel region and comprises: a gate electrode provided on the transparent substrate, a gate insulation layer provided on the gate electrode and covering the transparent substrate, a semiconductor layer provided on the gate insulation layer and corresponding to the gate electrode on the transparent substrate, and, source and drain electrodes provided on the semiconductor layer. The protection layer is provided on the source and drain electrodes of the thin film transistor and covers the gate insulation layer of the thin film transistor. The organic insulating layer is provided on the protection layer and covers the protection layer. The pixel electrode and the common electrode are provided on the organic insulating layer. Each contact hole penetrates the protection layer and the organic insulating layer to expose the drain electrode of each thin film transistor so that the pixel electrodes contact with the drain electrode of the thin film transistor. The organic insulating layer is formed with a recessed feature at a junction between one pixel region and another and is formed with a groove in a display area of the pixel region. The protection layer is a silicon nitride layer or a silicon dioxide layer, and the semiconductor layer is an amorphous silicon layer.

The present invention is also to provide a thin film transistor array substrate comprising a transparent substrate and multiple data lines and multiple gate lines perpendicular to each other so as to divide the transparent substrate into multiple pixel regions, in each of which a thin film transistor is positioned, wherein the thin film transistor array substrate further comprises: a protection layer provided on the thin film transistor and covers the transparent substrate, an organic insulating layer provided on the protection layer and covers the protection layer, a pixel electrode and a common electrode provided on the organic insulating layer; and wherein the organic insulating layer is formed with a recessed feature at a junction between one pixel region and another and is formed with a groove in a display area of the pixel region.

In one embodiment of the present invention, the thin film transistor comprises: a gate electrode provided on the transparent substrate, a gate insulation layer provided on the gate electrode and covering the transparent substrate, a semiconductor layer provided on the gate insulation layer and corresponding to the gate electrode on the transparent substrate, and, source and drain electrodes provided on the semiconductor layer; and wherein the protection layer is provided on the source and drain electrodes of the thin film transistor and covers the gate insulation layer of the thin film transistor.

In one embodiment of the present invention, the thin film transistor array substrate further comprises: multiple contact holes, each of which penetrates the protection layer and the organic insulating layer to expose the drain electrode of each thin film transistor so that the pixel electrode contacts with the drain electrode of the thin film transistor.

In one embodiment of the present invention, the protection layer is a silicon nitride layer or a silicon dioxide layer

In one embodiment of the present invention, the semiconductor layer is an amorphous silicon layer.

In one embodiment of the present invention, the materials of the pixel electrode and the common electrode are ITO or common metals.

The present invention is also to provide a manufacturing method of the thin film transistor array substrate, wherein the manufacturing method includes: step S10, providing a transparent substrate, on which multiple data lines and multiple gate lines are arranged perpendicular to each other so that the transparent substrate contains multiple pixel regions; step S20, forming a thin film transistor in each pixel region on the transparent substrate; step S30, forming a protection layer on the thin film transistor so that the protection layer is on the thin film transistor and covers the transparent substrate; step S40, forming an organic insulating layer on the protection layer so that the organic insulating layer is on the protection layer and covers the protection layer, while forming a recessed feature at a junction between one pixel region and another and forming the organic insulating layer with a groove in a display area of the pixel region.

In one embodiment of the present invention, the step S20 includes: step S201, forming a gate electrode on the transparent substrate; step S202, forming a gate insulation layer on the gate electrode so that the gate insulation layer is on the gate electrode and covers the transparent substrate; step S203, forming a semiconductor layer, which is corresponding to the gate electrode on the transparent substrate, on the gate insulation layer; and, step S204, forming source and drain electrodes on the semiconductor layer.

In one embodiment of the present invention, after the step S30, the method further comprises: step S31, forming a first contact hole on the protection layer at a position where is corresponding to the gate electrode for exposing the drain electrode; after the step S40, the method further comprises: step S41, forming a second contact hole on the organic insulating layer at a position where is corresponding to the first contact hole to connect the first contact hole with the second contact hole for exposing the drain electrode.

In one embodiment of the present invention, the protection layer is a silicon nitride layer or a silicon dioxide layer; and, the semiconductor layer is an amorphous silicon layer.

The present invention is also to provide a liquid crystal panel comprising: a first substrate and a second substrate that are disposed opposite to each other, and a liquid crystal layer and alignment films that are filled between the first substrate and the second substrate, wherein the first substrate is the above mentioned thin film transistor array substrate and the second substrate is a color filer substrate.

The thin film transistor array substrate according to the present invention can block lights from emitting through adjacent pixels when viewing a liquid crystal panel using the thin film transistor array substrate from sides with a large viewing angle by forming the organic insulating layer with a recessed feature at a junction of pixels which is not a display area and a groove in a display area of the pixel structure, so that color cast caused by viewing with a large viewing angle is avoided and display performances are improved.

### BRIEF DESCRIPTION OF THE DRAWINGS

FIG. 1 is a structural schematic view illustrating a pixel structure of a traditional liquid crystal panel;

FIG. 2 is a structural schematic view illustrating a pixel structure of the thin film transistor array substrate according to the present invention;

FIG. 3 is a schematic view illustrating a process flow of the thin film transistor array substrate according to the present invention;

FIGS. 4A-4H are schematic views illustrating a process flow of the thin film transistor array substrate according to the present invention;

FIG. 5 is a structural schematic view illustrating a pixel structure of an IPS liquid crystal panel having the thin film transistor array substrate according to the present invention.

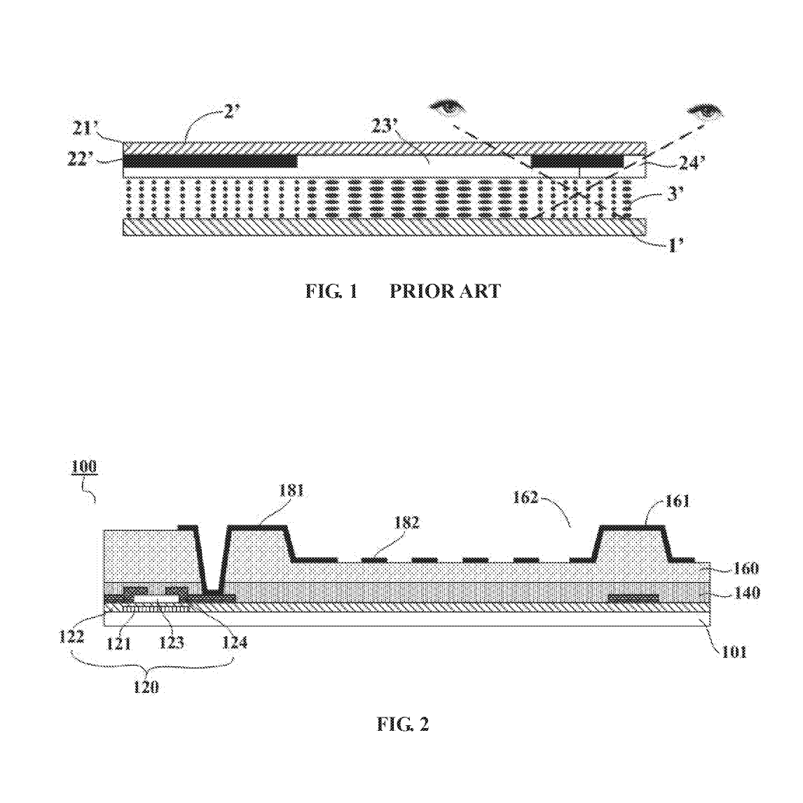

### DESCRIPTION OF THE INVENTION

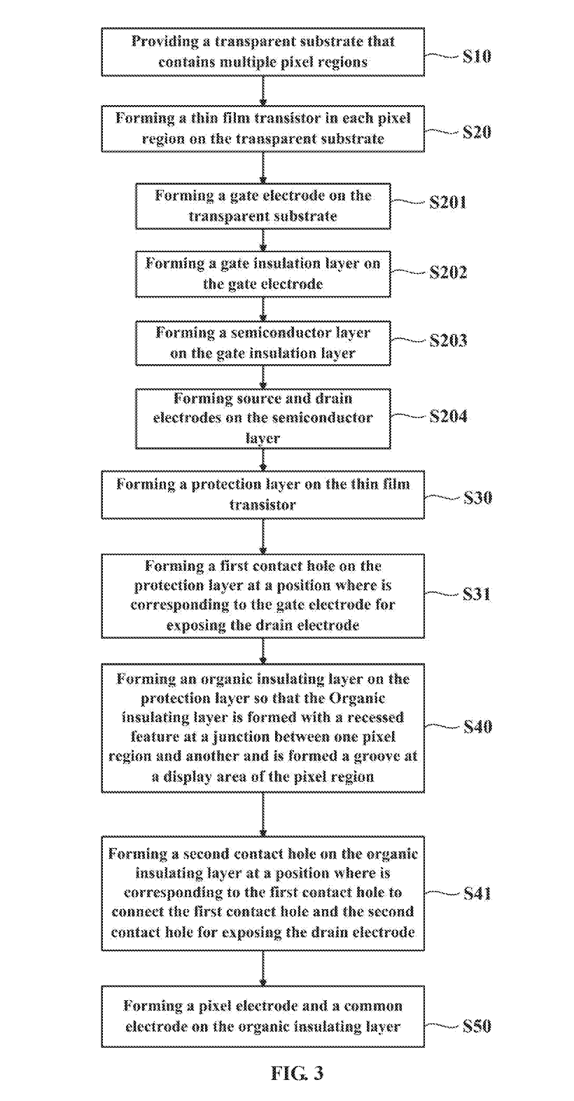

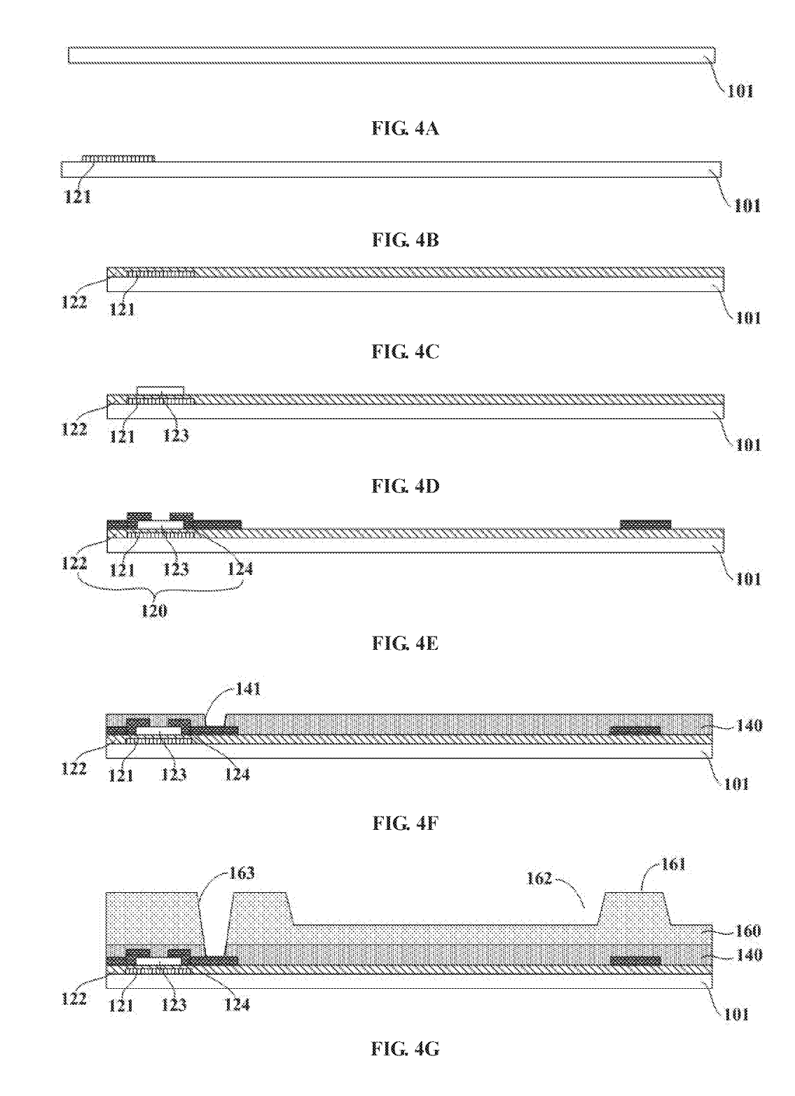

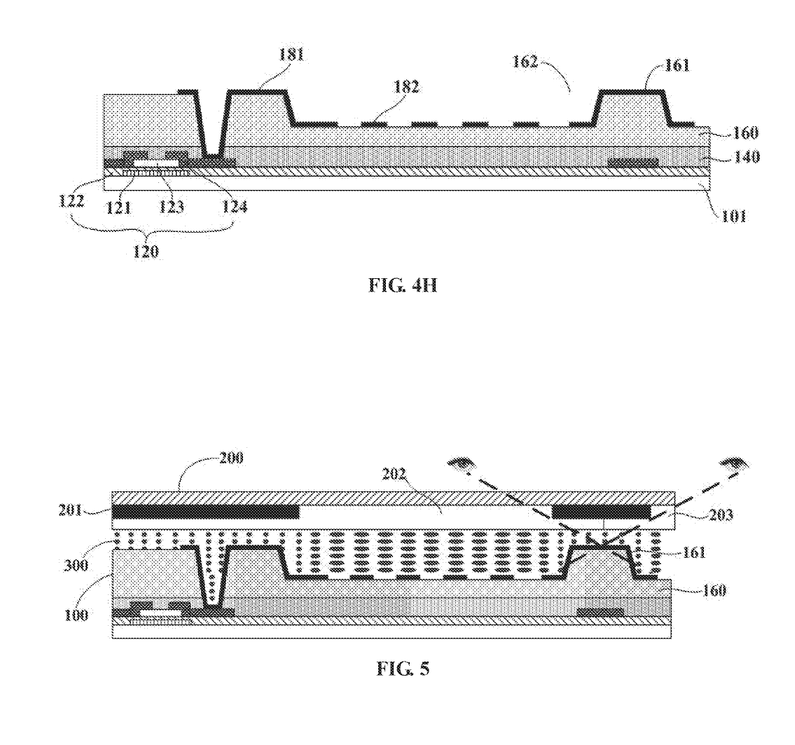

Embodiments, for purposes of explanation, are set forth in order to provide a thorough understanding of the present invention and not to limit the technical solution of the present invention. Directional terms described by the present invention, such as upper, lower, front, back, left, right, inner, outer, side, and etc., are only directions by referring to the accompanying drawings. And thus the used directional terms are used to describe and understand the present invention, but the present invention is not limited thereto. In particular, for conveniently describing, FIGS. 4A-4H are shown in simplification, wherein the number of the traces is simplified and some of details which are unrelated to the description are also omitted.

A thin film transistor array substrate 100 is provided in a preferred embodiment of the present invention, which has a transparent substrate 101 and comprises regular data lines and gate lines (not shown in the figure) that divides the transparent substrate 100 into multiple pixel regions. The thin film transistor array substrate 100 according to the present invention is described in detail hereinafter using a pixel region as an example.

Referring now to FIG. 2, the thin film transistor array substrate 100 comprises: a thin film transistor 120, a protection layer 140, an organic insulating layer 160, a pixel electrode 181 and a common electrode 182. The thin film transistor 120 comprises: a gate electrode 121, a gate insulation layer 122, a semiconductor layer 123, source and drain electrodes 124.

The detail structure of the thin film transistor array substrate 100 is described in detail hereinafter by referring to the FIG. 2.

As illustrated in figures, the detail structure of the thin film transistor array substrate 100 comprises: transparent substrate 101; a gate electrode 121 provided on the transparent substrate; a gate insulation layer 122 provided on the gate electrode 121 and covering the transparent substrate 101; a semiconductor layer 123 provided on the gate insulation layer 122 and corresponding to the gate electrode 121 on the transparent substrate; source and drain electrodes 124 provided on the semiconductor layer 123; a protection layer 140 provided on the source and drain electrodes 124 and covering the gate insulation layer 122; an organic insulating layer 160 provided on the protection layer 140 and covering the protection layer 140; a pixel electrode 181 and a common electrode 182 provided on the organic insulating layer 160. As illustrated in figures, the pixel electrode 181 contacts with the drain electrode 124 through contact holes. And as illustrated in figures, the organic insulating layer 160 is formed with a recessed feature 161 at a junction between one pixel region and another and is formed with a groove 162 in a display area of the pixel region.

The manufacturing method of the thin film transistor array substrate is described in detail hereinafter by referring to the FIG. 3 and FIGS. 4A-4H. Referring now to the FIG. 3 and FIGS. 4A-4H, the present invention is also to provide a manufacturing method of the thin film transistor array substrate. The manufacturing method includes the following steps.

Referring to step S10 and FIG. 4A, a transparent substrate is provided.

Referring to step S20, a thin film transistor 120 is formed in each pixel region on the transparent substrate 101. The step S20 includes: step S201, step S202, step S203, and step S204.

Referring to step S201 and FIG. 4B, a gate electrode 121 is formed on the transparent substrate 101.

Referring to step S202 and FIG. 4C, a gate insulation layer 122 is formed on the gate electrode 121, so that the gate insulation layer 122 is on the gate electrode 121 and covers the transparent substrate 101.

Referring to step S203 and FIG. 4D, a semiconductor layer 123 is formed on the gate insulation layer 122, wherein the semiconductor layer 123 is corresponding to the gate electrode 121 on the transparent substrate. Preferably, the semiconductor layer is an amorphous silicon layer.

Referring to step S204 and FIG. 4E, source and drain electrodes 124 are formed on the semiconductor layer 123.

Referring to step S30 and FIG. 4F, a protection layer 140 is formed on the thin film transistor 120, so that the protection layer 140 is on the thin film transistor 120 and covers the transparent substrate 101. That is, as illustrated in figures, the protection layer 140 also covers the gate insulation layer 122 of the thin film transistor 120. Preferably, the materials of the protection layer may be silicon nitride (SiNx) or silicon dioxide (SiO2).

Referring to step S31 and FIG. 4F, a first contact hole 141 is formed on the protection layer 140 at a position where is corresponding to the gate electrode 124 for exposing the drain electrode 124.

Referring to step S40 and FIG. 4G, an organic insulating layer 160 is formed on the protection layer 140, so that the organic insulating layer 160 is on the protection layer 140 and covers the protection layer 140; meanwhile, a recessed feature 161 is formed at a junction between one pixel region and another, and the organic insulating layer 160 is formed with a groove 162 in a display area of the pixel region.

Referring to step S41 and FIG. 4G, a second contact hole 163 is formed on the organic insulating layer 160 at a position where is corresponding to the first contact hole to connect the first contact hole with the second contact hole 163 for exposing the drain electrode 124.

Referring to step S50 and FIG. 4H, a pixel electrode 181 and a common electrode 182 are formed on the organic insulating layer 160. As illustrated in figures, the pixel electrode 181 contacts with the drain electrode 124 through the first contact hole and the second contact hole.

Moreover, the thin film transistor array substrate can be used in a liquid crystal panel. Referring now to FIG. 5, a structural schematic view illustrating a pixel structure of an IPS liquid crystal panel having the thin film transistor array substrate according to the present invention is illustrated. As illustrated in the FIG. 5, the present invention is also to provide a liquid crystal panel comprising: the thin film transistor array substrate 100 and a second substrate 200 that are disposed opposite to each other and liquid crystal compositions 300 filled between the first substrate 100 and the second substrate 200. The second substrate is a color filer substrate.

As illustrated in FIG. 5, multiple black matrixs 201 and multiple color filers (such as color filer G 202 and color filer B 203) are disposed on the color filer substrate 200. As illustrated in figures, a main feature of the IPS liquid crystal panel using the thin film transistor array substrate according to the present invention is that: the organic insulating layer 160 is formed with a recessed feature 161 at a junction of pixels (that is the junction between the color filer G 202 and color filer B 203). In this way, as illustrated in FIG. 5, lights are blocked from emitting through adjacent pixels by using the recessed feature 161 so as to avoid color cast caused by viewing with a large viewing angle.

The thin film transistor array substrate according to the present invention can block lights of pixel from emitting through adjacent pixels when viewing a liquid crystal panel using the thin film transistor array substrate from sides with a large viewing angle by forming the organic insulating layer with a recessed feature at a junction of pixels which is not a display area and a groove in a display area of the pixel structure, so that color cast caused by viewing with a large viewing angle is avoided and display performances are improved.

The present invention has been described with relative embodiments which are examples of the present invention only. It should be noted that the embodiments disclosed are not the limit of the scope of the present invention. Conversely, modifications to the scope and the spirit of the claims, as well as the equal of the claims, are within the scope of the present invention.

1. A thin film transistor array substrate comprising a transparent substrate, and multiple data lines and multiple gate lines that are perpendicular to each other for dividing the transparent substrate into multiple pixel regions, which further comprises: multiple thin film transistors, a protection layer, an organic insulating layer, a pixel electrode and a common electrode, and multiple contact holes, wherein, each thin film transistor is positioned in every pixel region and comprises:
a gate electrode provided on the transparent substrate,
a gate insulation layer provided on the gate electrode and covering the transparent substrate,
a semiconductor layer provided on the gate insulation layer and corresponding to the gate electrode on the transparent substrate, and,
source and drain electrodes provided on the semiconductor layer;
the protection layer is provided on the source and drain electrodes of the thin film transistor and covers the gate insulation layer of the thin film transistor;
the organic insulating layer is provided on the protection layer and covers the protection layer;
the pixel electrode and the common electrode are provided on the organic insulating layer; and,
each contact hole penetrates the protection layer and the organic insulating layer to expose the drain electrode of each thin film transistor so that the pixel electrode contacts with the drain electrode of the thin film transistor;
wherein the organic insulating layer is formed with a recessed feature at a junction between one pixel region and another and is formed with a groove in a display area of the pixel region; the protection layer is a silicon nitride layer or a silicon dioxide layer; and, the semiconductor layer is an amorphous silicon layer.

2. A thin film transistor array substrate comprising a transparent substrate, and multiple data lines and multiple gate lines that are perpendicular to each other for dividing the transparent substrate into multiple pixel regions, in each of which a thin film transistor is positioned, wherein the thin film transistor array substrate further comprises:
a protection layer provided on the thin film transistor and covers the transparent substrate;
an organic insulating layer provided on the protection layer and covers the protection layer;
a pixel electrode and a common electrode provided on the organic insulating layer;
wherein the organic insulating layer is formed with a recessed feature at a junction between one pixel region and another and is formed with a groove in a display area of the pixel region.

3. The thin film transistor array substrate according to claim 2, wherein the thin film transistor comprises:
a gate electrode provided on the transparent substrate,
a gate insulation layer provided on the gate electrode and covering the transparent substrate,
a semiconductor layer provided on the gate insulation layer and corresponding to the gate electrode on the transparent substrate, and,
source and drain electrodes provided on the semiconductor layer;
and wherein the protection layer is provided on the source and drain electrodes and covers the gate insulation layer of the thin film transistor.

4. The thin film transistor array substrate according to claim 3, wherein the thin film transistor array substrate further comprises:
multiple contact holes, each of which penetrates the protection layer and the organic insulating layer to expose the drain electrode of each thin film transistor so that the pixel electrode contacts with the drain electrode of the thin film transistor.

5. The thin film transistor array substrate according to claim 2, wherein the protection layer is a silicon nitride layer or a silicon dioxide layer.

6. The thin film transistor array substrate according to claim 3, wherein the semiconductor layer is an amorphous silicon layer.

7. A manufacturing method of the thin film transistor array substrate according to claim 2, wherein the manufacturing method includes:
step S10, providing a transparent substrate, on which multiple data lines and multiple gate lines are arranged perpendicular to each other so that the transparent substrate contains multiple pixel regions;
step S20, forming a thin film transistor in each pixel region on the transparent substrate;
step S30, forming a protection layer on the thin film transistor so that the protection layer is on the thin film transistor and covers the transparent substrate;
step S40, forming an organic insulating layer on the protection layer so that the organic insulating layer is on the protection layer and covers the protection layer, while forming a recessed feature at a junction between one pixel region and another and forming the organic insulating layer with a groove in a display area of the pixel region;
step S50, forming a pixel electrode and a common electrode on the organic insulating layer.

8. A manufacturing method according to claim 7, wherein the step S20 includes:
step S201, forming a gate electrode on the transparent substrate;
step S202, forming a gate insulation layer on the gate electrode so that the gate insulation layer is on the gate electrode and covers the transparent substrate;
step S203, forming a semiconductor layer, which is corresponding to the gate electrode on the transparent substrate, on the gate insulation layer; and,
step S204, forming source and drain electrodes on the semiconductor layer.

9. A manufacturing method according to claim 8, wherein after the step S30, the method further comprises:
step S31, forming a first contact hole on the protection layer at a position where is corresponding to the gate electrode for exposing the drain electrode;
after the step S40, the method further comprises:
step S41, forming a second contact hole on the organic insulating layer at a position where is corresponding to the first contact hole to connect the first contact hole with the second contact hole for exposing the drain electrode.

10. A manufacturing method according to claim 8, wherein the protection layer is a silicon nitride layer or a silicon dioxide layer; and, the semiconductor layer is an amorphous silicon layer.

11. The thin film transistor array substrate according to claim 3, wherein the protection layer is a silicon nitride layer or a silicon dioxide layer.
